(19) United States
(12) Patent Application Publication
(10) Pub. No.: US 2014/0068947 A1
(43) Pub. Date: Mar. 13, 2014

(54) METHOD FOR PRODUCING A BEARING RING, IN PARTICULAR FOR A TAPERED ROLLER BEARING

(71) Applicants: Markus Mantau, Veitsbronn (DE); Erich Lunz, Lonnerstadt (DE); Reinhard Kick-Rodenbücher, Nurnberg (DE); Peter Schuster, Zirndorf (DE); Klaus Geissdörfer, Herzogenaurach (DE); Harald Vornehm, Ammerndorf (DE); Alexander Reimchen, Herzogenaurach (DE)

(72) Inventors: Markus Mantau, Veitsbronn (DE); Erich Lunz, Lonnerstadt (DE); Reinhard Kick-Rodenbücher, Nurnberg (DE); Peter Schuster, Zirndorf (DE); Klaus Geissdörfer, Herzogenaurach (DE); Harald Vornehm, Ammerndorf (DE); Alexander Reimchen, Herzogenaurach (DE)

(73) Assignee: Schaeffler Technologies AG & Co. KG, Herzogenaurach (DE)

(21) Appl. No.: 14/004,279

(22) PCT Filed: Feb. 27, 2012
(86) PCT No.: PCT/EP2012/053268

§ 371 Date: Nov. 21, 2013

(30) Foreign Application Priority Data
Mar. 10, 2011 (DE) 10 2011 005 326.3

(51) Int. Cl. B23P 15/00

(52) U.S. Cl. CPC B23P 15/003
USPC 29/898

(57) ABSTRACT

A method for producing a bearing ring (20, 29), in particular a tapered roller bearing ring, including the following steps: making available an annular disc (8; 9), and forming the disc (8; 9) to provide a substantially cylindrical bearing ring and producing a raceway (19; 28) of the bearing ring in a single operation by extrusion. According to the invention, the method achieves the object of providing a simple method for producing bearing rings, in particular for tapered roller bearings, which delivers high unit numbers and in which it is possible to dispense with a finishing operation.

### FIELD OF THE INVENTION

The invention relates to a method for producing a bearing ring, particularly for a tapered bearing ring, based on a disc comprising a homogenous material as well as a bearing ring produced according to the method, particularly a tapered ball bearing.

From industry, the production of bearing rings is known for roller bearings, which particularly comprise the processing steps of deep drawing and/or embossing. Such methods require finishing operations of the blank produced, for example finishing by way of cutting the track of the bearing ring in the blank, and thus their implementation is expensive.

DE 10 2005 017 588 B3 describes a method for producing a bearing ring for a tapered roller bearing, in which an annular disc is provided and then an axial deep drawing process is performed. The blank requires finishing operations, for example an embossing step, in which the axially deep-drawn area of the blank is further processed in a shaping fashion.

DE 10 2005 028 093 B3 describes a method for a simultaneous production of an inner ring and an outer ring of a tapered roller bearing, in which an annular disc is provided, which is deformed into a cup-shaped body, with the tracks being formed at this cup-shaped body by way of an embossing step, with thereafter additional processing steps being required, particularly additional embossing steps.

EP 1 792 672 A1 describes a method for the production of a bearing ring in which, starting with an annular disc, this disc is deformed into an essentially cylindrical blank with an essentially constant wall thickness (e.g., FIGS. 39A to 39C), with thereafter the cylindrical blank requiring additional finishing steps.

WO 2008/151585 A1 describes a method for producing a bearing ring, particularly a ball bearing, in which two circular discs connected to each other are produced from a circular blank, into which the tracks are embossed, with thereafter the discs being finished into an essentially cylindrical bearing ring.

DE 29 38 812 C3 describes a method for producing a bearing ring from a compressed metallic granulate, with the track of the bearing ring being provided from a high-quality sheet metal. The sheet metal and the granulate are fastened to each other in a sintering step. The non-homogenous composite is further processed in an extrusion process into an essentially cylindrical blank. In a subsequent processing step the sheet metal of the blank is shaped into the form of the track by forging or precision forging. Here, the production of the track and the shaping of the bearing ring are implemented by two processing steps performed via different techniques.

DD 51759 A1 describes the production of a bearing ring for a roller bearing, with a solid cylindrical rod section being provided, with its exterior being provided with a cylindrical form by an inverse extrusion on a facial area of a cylindrical matrix, and with its interior being ejected as rejects. The rod section shows a thickness, which is considerably greater than the wall thickness of the cylindrical blank. The extension of the rod section in the direction of the force applied during the extrusion is approximately equivalent to the extension perpendicular in reference to this direction.

DE 968 638 B describes a method for the production of bearing rings, in which, starting with a solid rod section with a large thickness, it is deformed by hot pressing at a forging temperature of approx. 900° C. into a circular metal blank and said blank being forged by an extrusion process into a tower, with the tower comprising an outer ring and an inner ring, axially off-set in reference to each other and fastened to each other, representing a blank for further processing. The blank is separated and the two bearing rings are provided with their tracks via hot rolling and roll calibration. In particular bit dressing is described here, which is performed at high temperatures in a press arrangement.

EP 1 647 418 A2 describes a method for the production of a wheel bearing, which shows axially projecting fastening sections to fasten the bearing to the body of a vehicle, with the bearings embodied as an angular ball bearing being produced from a hollow-cylindrical or disc-shaped part by way of forging and in a final processing step the radially projecting fastening sections being produced by way of pressing. The blank of the wheel bearing produced here requires finishing.

EP 2 050 583 A1 describes a method for the production of a wheel bearing, showing axially projecting fastening sections to fasten the bearing at a body of a vehicle, with the wheel bearing being produced starting with a cylindrical part by way of cold forging, with a thermal post-processing of the tracks of the bearing being required.

### SUMMARY

The objective of the invention is to provide a simple method for the production of bearing rings, particularly for ball bearings, yielding high quantities and here allowing the avoidance of any finishing.

According to the invention this objective is attained in a method including the essential steps: Providing a circular disc, deforming said disc into an essentially cylindrical bearing ring, and producing a track of the bearing ring in a single processing step by way of extrusion.

During extrusion, the essentially planar circular disc is rotated in a single processing step such that the shape or the essentially cylindrical bearing ring is obtained, and simultaneously the track of the bearing ring is generated.

The extrusion is here executed as a one-step massive deformation, with the material of the disk, by way of applying high pressure, being made to flow in a deformation tool, particularly between a plunger and a matrix exhibiting a suitable design. Here, particularly the thickness of the disk changes due to material displacement during the extrusion. Here, the deformation tool ensures that the bearing ring obtained by such extrusion exhibits high size accuracy, good reproducibility, as well as high surface quality, so that any finishing is no longer required. In particular the risk of any scaling is prevented for the bearing ring produced this way. The process of extrusion is performed in a short period of time so that high quantities can be obtained in a short period of time.

Here, extrusion offers an additional advantage that particularly in tapered roller bearings with both bearing rings being produced by way of extrusion in a single processing step, a considerably reduced tolerance of the height of the bearing can be achieved compared to other production methods for bearing rings, so that additional abrasive reprocessing of the two bearing rings can be omitted. The tolerance of the height of the bearing reduced by this method allows the use of the bearings for applications, such as pump bearings.

The bearing rings produced in a single processing step by way of extrusion are immediately finished after a final process, for example curing, washing and deburring (for example by vibratory grinding) and the optional application of a bronzing layer, for example by way of wet-chemical immersion. Any further expensive finishing is omitted, here.

Preferably it is provided that the extrusion is performed as cold extrusion, thus particularly at room temperature, so that it is not necessary to additionally heat the disc.

Advantageously it is provided for the extrusion to be performed as forward extrusion.

If the bearing ring to be produced includes a ledge it is preferably provided for the ledge to be produced during the processing step of extrusion.

If the bearing ring to be produced includes a circumferential groove it is preferred for the groove to be produced during the processing step of extrusion.

In the event that an outer ring as well as an inner ring are to be produced it is preferably provided that the inner ring is produced from a first disc and the outer ring of the bearing from a second disc, with the two rings first being separated from a common circular blank.

Preferably it is provided for the disc to be produced from a hardenable steel material.

Further advantages and features are discernible from the attached claims as well as the following description of a preferred exemplary embodiment of the invention.

### BRIEF DESCRIPTION OF THE DRAWINGS

In the following the invention is described and explained in greater detail with reference to the attached drawings:

FIG. 1 shows a schematic illustration of a first preparatory step for implementing the method according to the invention,

FIG. 2 shows a schematic illustration of a second preparatory step for implementing the method according to the invention,

FIG. 3 shows a schematic illustration of a third preparatory step for implementing the method according to the invention,

FIG. 4 shows a schematic illustration of an initial state in a first exemplary implementation of the method according to the invention,

FIG. 5 shows a schematic illustration of a final state in the first exemplary implementation of the method according to the invention as shown in FIG. 4,

FIG. 5a shows a schematic illustration of an optionally performed step of the finishing immersion and calibration,

FIG. 6 shows a schematic illustration of an initial state in a second exemplary implementation of the method according to the invention,

FIG. 7 shows a schematic illustration of a final state in the second exemplary implementation of the method according to the invention as shown in FIG. 6,

FIG. 8 shows two bearing rings of a roller bearing, which are produced according to the two exemplary implementations of the method according to the invention as shown in FIGS. 4 and 5 and/or in FIGS. 6 and 7, in a schematic illustration,

FIG. 8a shows the height for a bearing, with its two bearing rings being produced according to the first and/or the second exemplary implementation of the method according to the invention,

FIG. 9 shows a schematic illustration of a variant of the processing step shown in FIG. 5 and/or FIG. 5a, and

FIG. 10 shows a schematic illustration of a variant of the processing step shown in FIG. 7.

### DETAILED DESCRIPTION OF THE PREFERRED EMBODIMENTS

In a first step for the exemplary implementation of the method according to the invention a circular disc is provided.

FIGS. 1 to 3 show three successive, preparatory steps in the exemplary embodiment of the method according to the invention, in which the circular disc is produced and provided for the method according to the invention.

FIG. 1 shows a sheet 1 comprising a hardenable steel material, which is arranged in a punching tool 2. A circular blank 3 is punched out of the sheet 1 in a first, preparatory step, thus a cut-out with a circular contour.

FIG. 2 shows a circular blank 3, in which in a second punching tool 4 a central circular section 5 is punched out, so that in a second preparatory step a circular washer 6 develops, i.e. a section with a circular exterior contour and a circular interior contour.

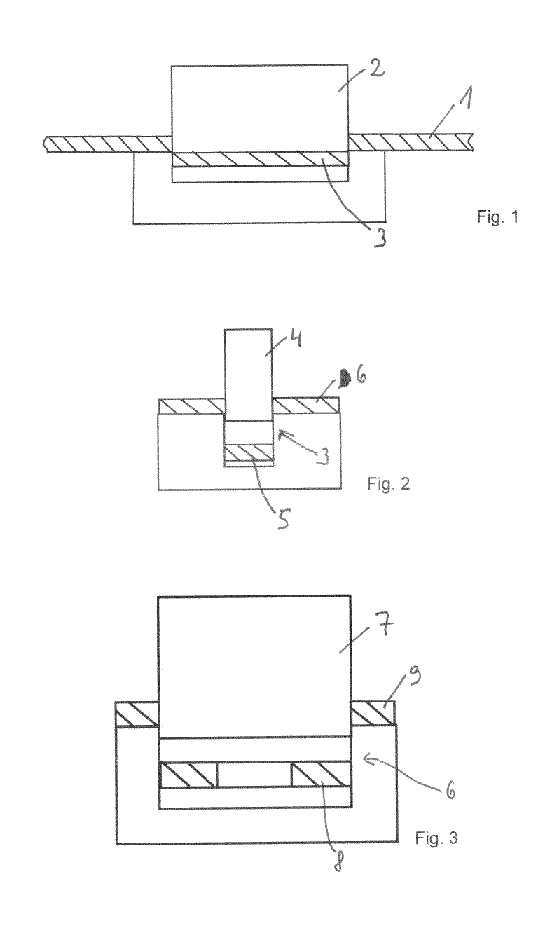

FIG. 3 shows a circular washer 6 in a third punching tool 7, with in a third preparatory step a first disc 8, located inside, and a second disc 9, located outside, are separated from each other. The two discs 8, 9 each exhibit a circular exterior contour and a circular interior contour, with here the interior contour of the outer disc 9 showing a diameter which is essentially equivalent to the diameter of the exterior contour of the inner disc 8.

In the subsequent first exemplary implementation of the method according to the invention a bearing ring is produced from the first disc 8, located inside, namely an inner ring of a tapered roller bearing. From the second, outer disc 9, in the subsequent second exemplary implementation of the method according to the invention, another bearing ring is produced, namely an outer ring of a tapered roller bearing. For the implementation of the method according to the invention it is also understood that the discs 8, 9 provided not necessarily need to be produced according to the preparatory steps of FIGS. 1 to 3.

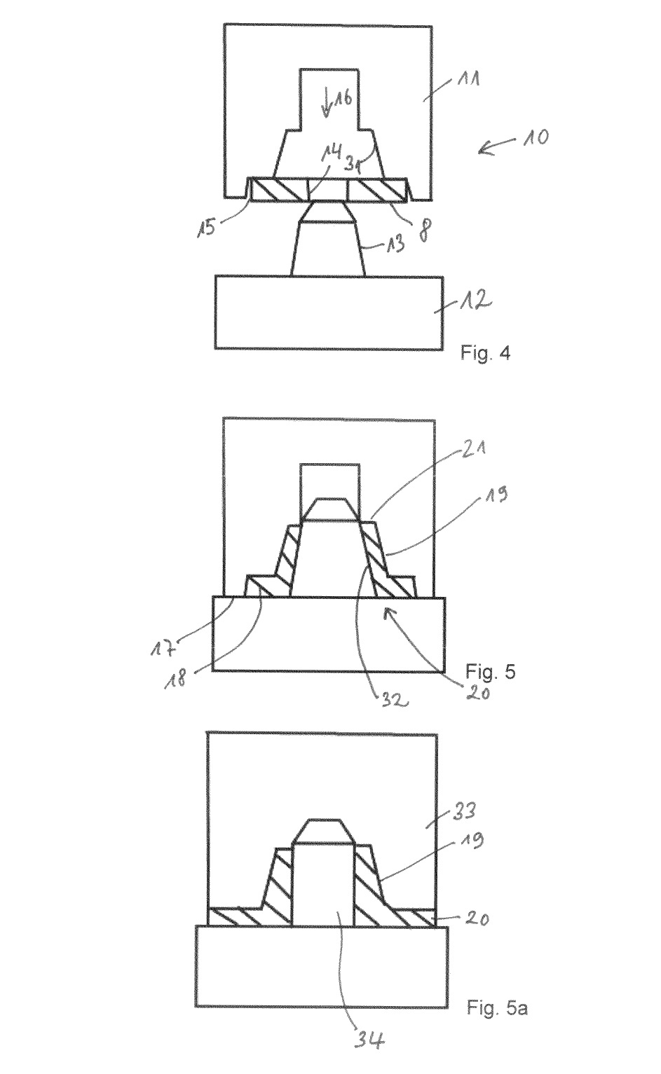

FIG. 4 shows the first disc 8, for example produced according to the preparatory steps shown in FIGS. 1 to 3, which is arranged in a deforming tool 10. The deforming tool 10 comprises an essentially hollow-cylindrical, unilaterally open plunger 11, which has at the open end a three-stage, tapering cross-sectional contour 31, and a matrix 12 with a blunt-conically tapering mandrel 13. The interior contour 14 rests on the blunt-conically tapering mandrel 13. The plunger 11 presses onto an area section of the first disc 8 adjacent to the exterior edge 15.

In a relative motion between the matrix 12 and the plunger 11, particularly when the plunger 11 is lowered towards the fixed matrix 12 in the direction of the arrow 16, the material of the first disc 8 is deformed by way of extrusion and the shape of the bearing rings yielded is determined by the form of the plunger and the matrix 12.

FIG. 5 shows the final state, in which the plunger 11 sectionally contacts the matrix 12 and by the extrusion the form of the bearing ring is determined by the area between the matrix 12, particularly a first section 32 of the two conically tapering sections of the mandrel 13, and the gradual cross-sectional contour 31 of the plunger 11.

When executing the extrusion according to FIGS. 4 and 5 the interior edge 14 is deformed upwards and the exterior edge 15 is deformed downwards, particularly laterally along a plane 17 of the matrix 12. The essentially planar disc 8 is inverted during the extrusion into an essentially cylindrical ring with a ledge, with its face developing from the interior edge 14 of the disc 8 and its ledge 18 from the exterior edge 15 laterally caulked along the plane 17. The ledge 18 here has developed during the processing step of extrusion, in the largely plastic deformation of the material of the disc 8.

FIG. 5 shows the final state of the extrusion of the first disc 8. A ledge 18 (FIG. 8) has formed by the sectional, plastic deformation of the material along the plane 17 of the matrix 12, due to the tapered contour of the plunger 11 a diagonal track 19 of an inner ring 20 (FIG. 8), which after the removal from the matrix 12 requires no further finishing. Discontinuities are discernible at a facial area 21 of the inner ring 19, which are caused by the plunger 11 and allow conclusions to be drawn on the extrusion as the production method. Surface contours also develop at other points of the surface of the bearing ring produced, which are characteristic for the extrusion process.

The embodiment of the essentially cylindrical ring with the formation of the ledge 18 and the track 19 of the inner ring that has developed is here yielded in a single processing step, namely the motion of the plunger 11 in reference to the matrix 12.

The inner ring—blank shown in FIG. 5 comprises a conically inclined track 19, however due to the first conical section 32 of the mandrel 13 shows a slightly inclined, non-cylindrical inner casing surface.

FIG. 5a shows an optionally executed processing step of a compression finishing and calibrating, with in the optional processing step a second tool, namely a calibration tool 33, is guided onto the inner ring-blank and deforms it at a cylindrical mandrel 34 such that the inner ring 20 yielded is provided with a cylindrical inner casing surface.

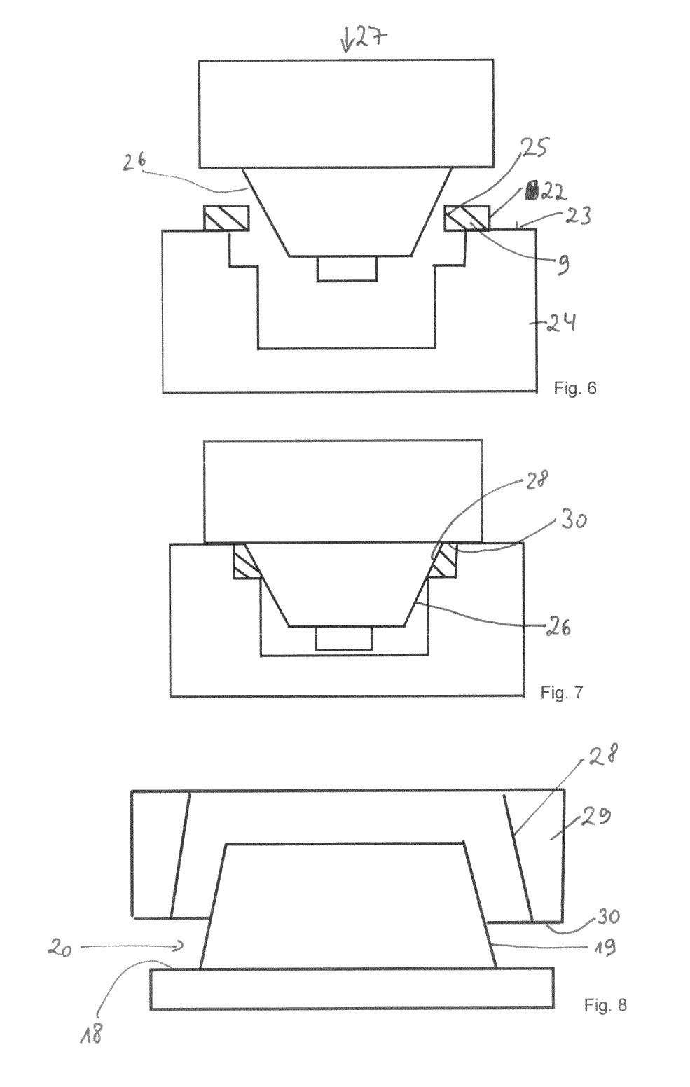

FIGS. 6 and 7 show the production of the outer ring of a tapered roller bearing, starting with the second disc 9.

The second disc 9 is placed with a section abutting an exterior edge 22 onto a contact area 23 of an essentially hollow-cylindrical matrix 24, an interior edge 25 of the disc 9 projecting beyond the hollow space of the matrix 24 towards a conically expanding plunger 26.

In a relative motion of the plunger 26 in reference to the matrix 24, for example along an arrow 27 in reference to the fixed matrix 24, the exterior edge 22 of the disc 9 is pushed upwards and the interior edge 25 downwards and the disc 9 overall is inverted into an essentially cylindrical bearing ring, with the incline of the plunger 26 generating a diagonal track 28 (FIG. 8). Here, particularly an outer ring 29 develops, in which at least one facial area 30, which developed from the exterior edge 22 of the disc 9, shows discontinuities, which are caused by the plunger 26. Here, the essentially hollow cylindrical shape of the bearing ring 29 and the diagonal track 28 have been formed by way of extrusion in a single processing step.

FIG. 8a shows a tapered roller bearing, with its outer ring 29 has been produced according to the above-described second exemplary embodiment and its inner ring 20 according to the above-described first exemplary embodiment, with the blunt-tapered roller bodies not being shown here. A height 35, defined as the axial distance between the facial area 36 of the outer ring 29 and the facial area 37 in the proximity of the ledge 18 of the inner ring 20 shows in this bearing, as well as in other bearings, with their two bearing rings each being produced based to the method according to the invention, a considerably lower statistic tolerance during mass production than other bearings, with their respective bearing rings being produced via different production methods. Due to the method according to the invention the height 35 of the bearing can be easier reproduced in mass production within a predetermined tolerance range. In particular, for the bearing produced in FIG. 8a any finishing of the entire assembled bearing can be dispensed with, particularly with the goal to bring the tolerance of the height 35 into a narrower, permitted range, with the two bearing rings here produced based to the method according to the invention being particularly suited for certain applications, such as pump bearings, due to the tolerance of the height 35 being reduced as a result of this method.

In the above-described two exemplary embodiments of the method the extrusion has respectively been performed as forward extrusion.

The extrusion was respectively performed at room temperature, without any additional heating of the discs 8, 9 prior to contacting the plunger 11, 16, so that the extrusion was performed as cold pressing.

In the above-described first exemplary embodiment it was provided that the inner ring 20 comprised a ledge 18, which was produced together with the production process of the essentially cylindrical bearing ring and the production of the track 19 in a single processing step by way of extrusion. It is understood that other embodiments at the bearing ring, for example particularly a groove at the inner ring or at the outer ring can also be produced in the processing step using extrusion. For example it may be provided that the plane 17 (FIG. 4) of the matrix 12 shows a circumferential projection in reference to the mandrel 13, so that the projection acts as a circumferential groove in the bearing ring produced.

In the above-described exemplary embodiment of the production of the inner ring (FIGS. 4 to 5a) the mandrel 13 exhibited a first conical section 32, so that only in the subsequent step of compression finishing and calibrating (FIG. 5a) the inner ring 20 obtains a cylindrical casing surface. It is understood that the mandrel 13, which is extruded, may already exhibit a cylindrical form so that the optional processing step of compression finishing and calibrating, shown in FIG. 5a, can be omitted.

In both above-described exemplary implementations of the method respectively the production of a bearing ring 20, 29 of a tapered roller bearing is provided, with the respective bearing ring 20, 29 comprising a planar track 28, 19, in its cross-section limited with a sectionally straight contour, which track is generated by a conical design of the respective plunger 11, 26. It is understood that the method may also be provided for the production of a bearing ring with its track not being planar but being curved, thus for example being limited by an arc-shaped contour over parts of its cross-section. The method can particularly be provided to produce an exterior and/or inner ring of an angular ball bearing.

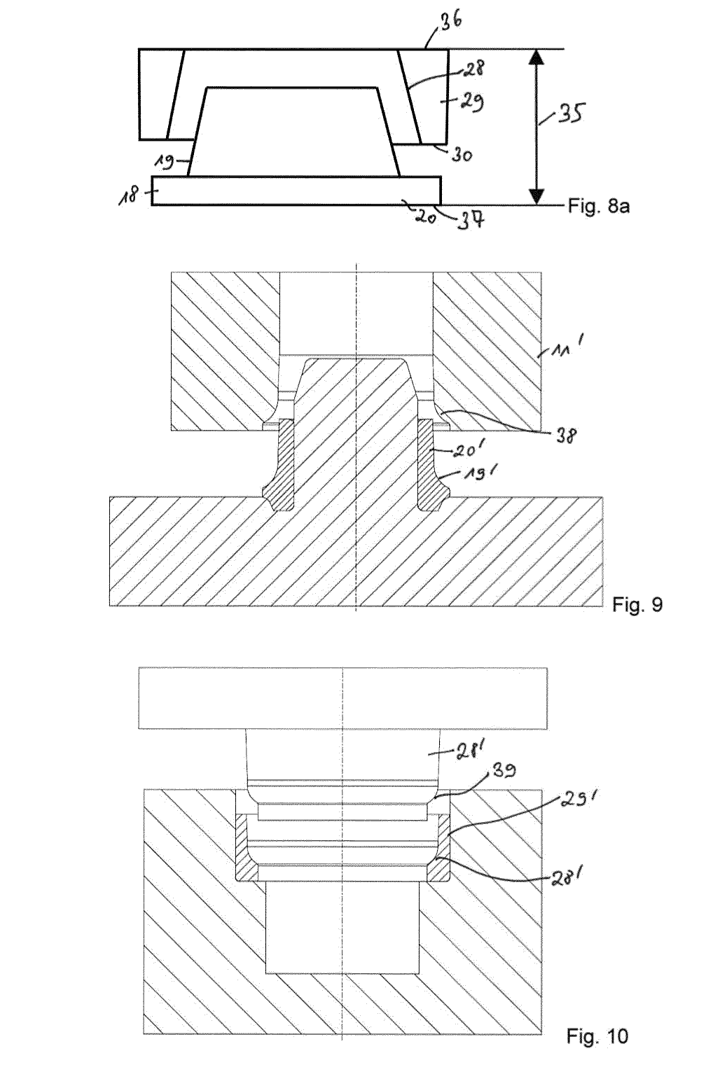

FIG. 9 shows a variant of the processing step shown in FIGS. 5, 5a for the production of an inner ring 20′ of an angular ball bearing, with the bearing ring 20′ comprising a sectionally curved track 19′, which is formed by a curved section 38 of an appropriately selected plunger 11′.

FIG. 10 shows in a variant of the processing step shown in FIG. 7 the production of an outer ring 29′ of an angular ball bearing, with the bearing ring 29′ showing a sectionally curved track 28′, which is formed by a curved section 39 of an appropriately embodied plunger 28′.

### LIST OF REFERENCE CHARACTERS

1 sheet

2 punching tool

3 circular blank

4 second punching tool

5 central section

6 washer

7 third punching tool

8 first disc

9 second disc

10 deforming tool

11 plunger

11′ plunger

12 matrix

13 mandrel

14 interior edge

15 exterior edge

16 arrow

17 plane

18 ledge

19 track

19′ track

20 inner ring

20′ inner ring

21 facial area of the inner ring 20

22 exterior edge

23 contact area

24 matrix

25 interior edge

26 plunger

26′ plunger

27 arrow

28 track

28′ track

29 outer ring

30 facial area of the outer ring 29

31 cross-sectional contour of the plunger 11

32 conical section of the mandrel 13

33 calibration tool

34 cylindrical mandrel

35 height

36 facial area of the outer ring 29

37 facial area of the inner ring 20

38 section of the plunger 11′

39 section of the plunger 26′

1. A method for the production of a bearing ring, comprising the steps: providing a circular disc and deforming the disc into an essentially cylindrical bearing ring and producing a track of the bearing ring in a single processing step by way of extrusion.

2. A method according to claim 1, wherein the extrusion is performed as a forward extrusion.

3. A method according to claim 1, wherein the extrusion is performed as cold compressing.

4. A method according to claim 1, wherein the bearing ring comprises a ledge, and the ledge is produced during the extrusion processing step.

5. A method according to claim 1, wherein the bearing ring comprises a circumferential groove, and the groove is produced in the extrusion processing step.

6. A method according to claim 1, wherein an inner ring is produced from a first disc and an outer ring of the bearing from a second disc, the method further comprising first separating the two discs from a common circular blank.

7. A method according to claim 1, wherein the disc is produced from a hardenable steel material.

8. A bearing ring produced according to claim 1.
